(19) United States
(12) Patent Application Publication
(10) Pub. No.: US 2026/0304042 A1
(43) Pub. Date: Oct. 1, 2026

(54) LOUDSPEAKER WITH TOROIDAL INFLATABLE MEMBRANE

(71) Applicant: Michele Maria ALDINIO, Monza (IT)

(72) Inventor: Michele Maria ALDINIO, Monza (IT)

(21) Appl. No.: 19/475,985

(22) PCT Filed: Apr. 10, 2024
(86) PCT No.: PCT/IB2024/053499

§ 371 Date: Oct. 16, 2025

(30) Foreign Application Priority Data
Apr. 18, 2023 (IT) 102023000007401

(51) Int. Cl. H04R 7/12; H04R 1/02; H04R 1/22; H04R 7/16; H04R 9/06

(52) U.S. Cl. CPC H04R 7/12; H04R 1/025; H04R 1/028; H04R 1/22; H04R 7/16; H04R 9/06

(57) ABSTRACT

A loudspeaker comprises a magnet, a movable coil, a support element and a membrane connected to the coil and which converts the movement of such coil into sound, said membrane being inflatable. The membrane is made of a single piece, is toroidal-shaped, can be replaced and it protrudes from the support element, said toroidal membrane generating a wide spectrum sound and allowing to reproduce—in the space and in a substantially isotropic manner—both low frequency sounds with their harmonics, as well as the medium and high frequency.

The present invention relates to a device for producing sound and listening to music that is a loudspeaker according to the preamble of the main claim.

### STATE OF THE ART

As it is known, a common loudspeaker comprising various components such as a permanent magnet or a solenoid passed through by a current (hereinafter, generally indicated as “magnet”), a basket which defines a structure for supporting the loudspeaker, a movable coil associated with an elastic suspension element or spider, an element connected to the movable coil and adapted to transform the movement of the latter into a sound, and a support for the movable coil. Such element which transforms the movement of the coil is commonly referred to as a cone or diaphragm or membrane.

As known, the loudspeaker converts an electrical signal (which reaches the coil immersed in the magnetic field generated by the magnet and movable therein) into soundwaves generated by the displacement of the membrane (or cone or diaphragm). In particular, specific loudspeakers are known capable of reproducing a portion of the audible band:
1. subwoofer (for ultra-low frequencies)
2. woofer (for low frequencies)
3. midrange (for medium frequencies)
4. Tweeter (for high frequencies)

Usually, the loudspeakers require an acoustic box (or closed box or vented box) into which they are inserted with all their components. The loudspeakers are the core of the acoustic boxes and they are the elements that actually create the soundwaves, while the boxes are the elements that enclose the loudspeakers (entire block). The acoustic box retains the wave generated in the rear area of the loudspeaker preventing it from destructively interfering with the wave generated externally by the front area of the loudspeaker; as a matter of fact, the loudspeaker generates two waves in phase opposition which would therefore tend to nullify each other, preventing a good propagation of the wave into the surrounding environment. However, in this manner the entire rear wave remains unused (that is the efficiency of the wave is not exploited), if not just partially in some systems through an opening (bass reflex) created in the vented box or the insertion of another passive cone or of another trumpet-like opening in the vented box. As a result, such box must be large.

A further aspect relates to woofers currently in use and available on the market: the woofers (loudspeaker designed to reproduce the low frequencies) have consistent dimensions and weight, which are much higher than those of the other loudspeakers. The system generally consists of a cone or membrane with a rather large diameter, proportionate metal basket, with heavy and robust coil and magnet. The reason for the larger dimension of the woofer lies in the fact that in order to be emitted abundantly, appropriately and in a balanced manner, low frequencies require a large membrane with a large vented box which contributes to emitting the correct sound, and therefore an appropriate power to make it vibrate.

WO2017089875—Inflatable Sound System Jun. 1, 2017—PCT/IB2016/001464—discloses the combination, to complete loudspeakers inserted into specific housings, of extensible or inflatable resonance chambers, which tend to slightly amplify the low frequencies of the loudspeaker used as a sound source. However, having a small membrane and not being directly connected to the resonance chamber, such speaker is not per se capable of emitting low or ultra-low frequencies, and therefore—together with the inflatable chamber—it does not allow to correctly and significantly amplify the sound emitted by the loudspeaker. The inflatable chamber is not directly connected to the vibrating coil, but it only acts as a mild resonance chamber for some frequencies emitted by the combined loudspeaker; such chamber is not per se a vibrating membrane which generates the sound, like in a normal loudspeaker.

US20180048949 Inflatable Speaker Pub. n. 20180048949-Feb. 15, 2018 discloses an extensible and inflatable vented or acoustic box applied to a loudspeaker, having a membrane, basket, fixing structure, etc. Such solution, in which the acoustic or vented box does not replace the vibrating membrane in generating the sound, only makes the vented box easier to transport, when collapsed, but it does not solve the problem of low frequencies at the origin, just like it does not solve the problem of the number of components required. The prior art solution reveals the same drawbacks as the prior art document mentioned above.

There are inflatable structures positioned around the loudspeaker, with sealant parts, in order to make the loudspeaker impact-proof, waterproof, floating, luminous. One of such solutions is described for example in US20090136076 Portable Inflatable and Illuminative Speaker—May 28, 2009. However, these and other similar solutions of the prior art only add characteristics to previously existing and complete loudspeakers or audio systems without solving the problems highlighted above.

US2009028369A1 describes a toroidal element associated with a rigid cone in a common loudspeaker, and adapted to support such cone and allow the movement thereof.

In such prior art solution, like the one described in the Italian patent application no. 101998900707532, and also in US 20018-0316997, the inflatable element is not directly connected to the coil of the loudspeaker and the inflatable element per se is not the source of the sound and it vibrates very little, receiving only the waves transmitted through the air by the loudspeaker to which it is connected and therefore only amplifying them slightly. In addition, in such prior art documents, the use of piezoelectric transducers confirms the unintended emission of low frequencies.

Even the solution described in U.S. Pat. No. 4,638,207, Piezoelectric film balloon speaker, where to an inflatable element there are applied piezoelectric films, for the sound source type (the piezoelectric loudspeakers are adapted to the emission of acute sounds, but they do not vibrate appropriately to emit a bass sound) does not allow to reproduce significant low frequencies.

WO1997022225—Sound Reproduction Device or Microphone, describes a vibrating coil which vibrates the centre of a rocker arm structure (inflated) with two lateral spheres; however, as mentioned by the prior art document, only part of the inflated membrane vibrates, and only or mainly its central part, that is the small one which is therefore not adapted to effectively reproduce the low frequencies. As a matter of fact, the document confirms that the sound can be compared to a portable/personal radio, which can also be sold as a gadget, and it is not designed to emit deep or intense waves.

DE102004007020 describes a loudspeaker whose membrane is formed by inflatable material. Therefore, this prior art document highlights that a loudspeaker with inflatable membrane, filled with air, is known. Generally, there is described an “inflatable cover” which takes the shape of a membrane when inflated.

DE'020 does not disclose a toroidal-shaped membrane, but a membrane that is generally flat, inflatable or, in a different embodiment, with a double wall structure or with double flat wings. In this case, the membrane is stiffened by walls formed by expensive carbon nanotubes embedded in a plastic material or expensive Kevlar fibres embedded in the membrane; this allows to create a high pressure between the walls of the membrane. This is obtained using a compressor.

Nothing in the prior art document suggests providing a toroidal membrane. Furthermore, the loudspeaker thus made needs a large basket for containing it. DE4302593 describes a loudspeaker with a plurality of membranes for loudspeaker contained in the basket. Such membranes are variously shaped and they are described always as formed by at least two parts (solution of FIGS. 1 and 2) or several parts (FIG. 3).

The object of the solution in DE4302593 is to overcome the problem of the partial oscillations of the diaphragms of the loudspeakers. Due to the fact that the membranes are always contained in the basket, the sound generated by the loudspeaker of the prior art document is irradiated only frontally (as it happens in all known loudspeakers) and to emit low-frequency sounds, the basket and the vented box must be large, and this entails the problems outlined above relating to the overall dimensions, weight and cost of woofers and the vented boxes into which they are inserted.

### TECHNICAL PROBLEMS

A problem that is strongly felt in the field of audio reproduction, that the prior art has not been able to solve until now, lies in the emission of low frequencies in loudspeakers that are small, light, easy to transport and cost-effective. Amplifiers and loudspeakers that are powerful and small at the same time can be built; however, such devices are not capable of emitting low frequencies and relative harmonics mainly due to the small surface of the vibrating membrane.

Therefore, in the prior art solutions:
no small loudspeaker is capable of emitting high quality low frequencies given that such frequencies require a large and rigid membrane (and therefore a large and heavy basket), as well as relative vented box;
the high-quality low frequencies are emitted by large loudspeakers;
loudspeakers which are not combined with others are capable of mainly spreading the sound in the front part;
in order to operate efficiently and emit high quality sounds (to amplify and control the output sound), the prior art loudspeakers need a vented box into which the entire loudspeaker comprising the membrane and all its components (coil, magnet, heavy metal basket etc.) is inserted; therefore, sound equipment (box and loudspeaker) that are cumbersome, heavy and generally expensive are obtained. In addition, this jeopardises the benefit of the miniaturisation of the other components e.g. the audio player, amplifier, etc. connected to such sound equipment.

An object of the present invention is to provide high quality loudspeakers adapted to emit significant low-frequency sounds, without any need to use cumbersome, heavy and expensive components such as woofers with large heavy metal basket, magnet and coil, heavy wooden acoustic box and large membrane made of cardboard or other rigid synthetic materials.

Furthermore, another object of the present invention is to provide a loudspeaker whose size can be reduced, which-when not being used-has a volume/overall dimensions measuring a few centimetres and weighing a few grams, that is a loudspeaker having a pocket-size.

Another object is to provide a loudspeaker of the type mentioned above which is cost-effective compared to systems of the same quality, also making the shipping-transportation-storage cost effective (also due to the low weight and overall dimensions when small in size).

Another object is to provide a loudspeaker which, unlike those of the prior art, is capable of propagating the sound in the space in a substantially isotropic manner. Another object is to provide a loudspeaker that does not require the use of a cumbersome and expensive vented box associated therewith.

A further object of the present invention is also to provide the loudspeaker and stereo system which is part of a design object (true industrial design, where the beautiful and essential shape is above all functional), which can be arranged and which can be used in various environments, precarious situations or stable installations, given its pleasant visual appeal and basically zero overall dimensions, for example when hung to a support.

Furthermore, another object of the present invention is to combine the loudspeaker with other loudspeakers or inserted in portable systems poor of low frequencies.

Furthermore, an object of the present invention is to be used as a subwoofer.

Furthermore, an object of the present invention is to provide a loudspeaker which can be connected, by using Bluetooth devices or additional cables, to a plurality of systems, arranged in different areas, therefore covering a very broad listening surface.

Furthermore, another object of the present invention is to provide a loudspeaker which, if placed close to a wall, can generate a bass reflex effect, depending on the distance from the walls or from other rear acoustic obstacles.

Furthermore, another object of the present invention is to enable the simultaneous emission of low frequency sounds and the production-amplification of high frequency sounds.

A further object of the present invention is also to provide the loudspeaker which can be adapted to the timbre needs of the user so as to obtain different acoustic and timbre results depending on the position of the loudspeaker in the space or replacing the membrane with a different size.

These and other objects which shall be more apparent to the person skilled in the art are attained by a loudspeaker according to the attached claim.

### BRIEF DESCRIPTION OF THE DRAWINGS

For a better understanding of the present invention, the attached drawings are attached hereto, purely by way of non-limiting example, wherein:

FIGS. 1A-1D show respectively top and perspective, lateral, bottom and enlarged views from one side, of a loudspeaker obtained according to the invention;

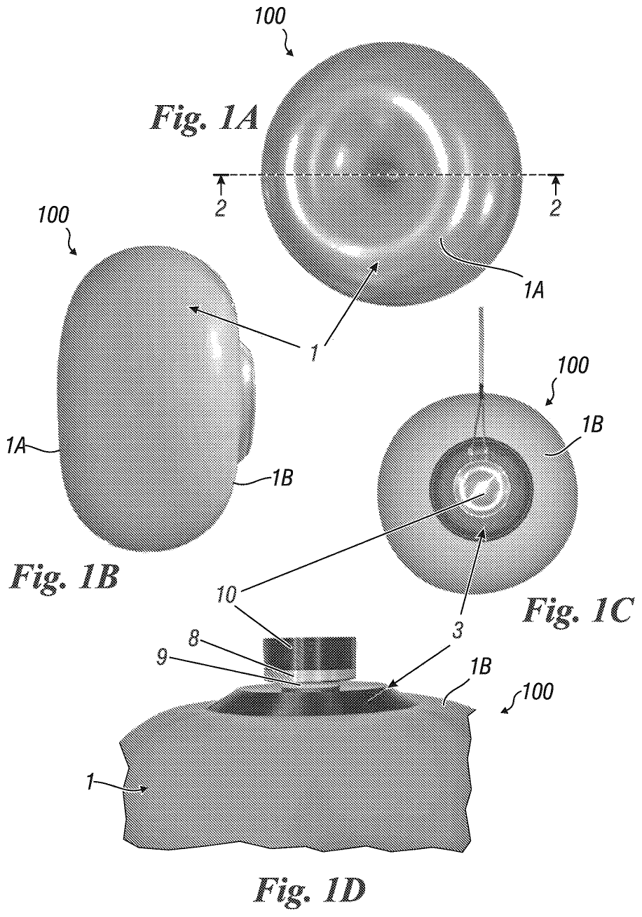

FIG. 2 shows a schematic section according to line 2-2 of FIG. 1A;

FIG. 3 shows a view similar to FIG. 2, but in exploded view, of the components of the loudspeaker of FIG. 1;

FIGS. 4A and 4B respectively schematically show an example of use of the loudspeaker of FIG. 1, shown in a cross-sectional view and a bottom view of the loudspeaker of FIG. 4A with some parts omitted for the sake of greater clarity;

FIG. 5 shows—by way of example—the method of sound emission of the loudspeaker of FIG. 1;

FIG. 6 shows a different embodiment of the invention shown in a schematic section; and

FIGS. 7A and 7B respectively show a top view and a perspective lateral view of the different embodiment of the invention of FIG. 6.

With reference to the aforementioned figures, the loudspeaker according to the invention is indicated in its entirety with 100. It comprises a vibrating or movable coil 10 associated, through a screw 9 (or alternatively bayonet) coupling system, with a support body 8. Such coil 10 cooperates with a common magnet (not shown) for generating the sound with an electric and mechanical component associated therewith. Such members are per se known and they will not be described; they are included in the expression “coil”.

The body 8 is perforated in 8A where there is provided for a closing cap 5. To such body 8 there is integrally joined an element 3 to which there is therefore directly fixed the coil 10 (through the body 8) and having a plate 3A and an edge 4, that is flat shaped to form a truncated cone or spoked with truncated cone shape (concave or convex). In this case, the spokes may be foldable so as to allow the folding on the plate, while providing rigidity thereto.

An inflatable and toroidal membrane 1 is directly associated with the coil 10, by constraining to the support element 3. Such membrane forms the diaphragm of the loudspeaker 1 and spreads the sound in the air generated by the common movement of the vibrating coil 10 to which it is integrally joined through the element 3 and in particular through the plate 3A. Therefore, the element 3 supports the membrane 1 (constrained to such element); therefore, the element 3 will be indicated as the support element 3.

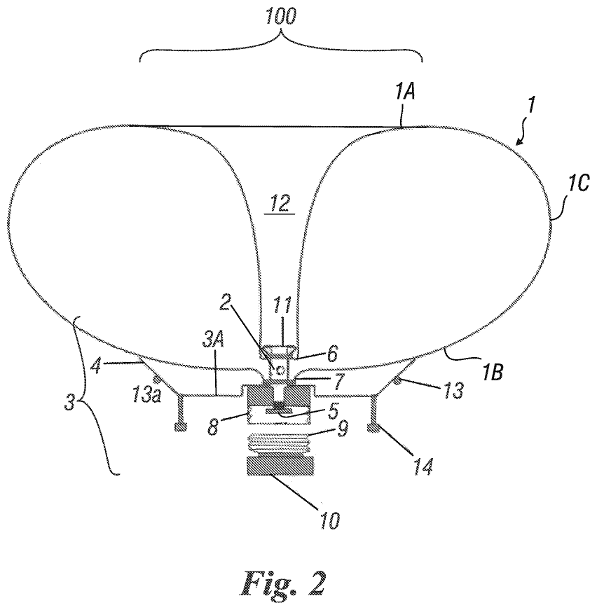

The toroidal membrane is made of a single piece, it has a cone-shaped central part 12 with trumpet-like or horn loading and it extends both above and laterally from the support element 3 and it therefore has, with reference to the element 3, an upper, free face or surface 1A and a lower, free face or surface 1B (arranged laterally to the support element 3 or to the plate 3A and protruding on one side of the latter) connected by a lateral surface 1C (see FIG. 2).

Given that the membrane is integrally joined with the plate 3A, the edge 4 (for example spoked) also confers rigidity to the membrane so that it vibrates integrally joined with the plate 3A and therefore with the coil 10 integrally joined therewith.

Due to its shape and size, the membrane 1 acts as a woofer, therefore making the use of an independent heavy, cumbersome and expensive vented box useless.

Usually, the membrane of a conventional woofer, given the necessary large size, but also lightness, sensitiveness and rigidity, must be contained in a large basket which protects it. This entails that the woofer cannot be transported easily and the basket, in turn, must be contained in a vented box which improves the sound thereof, but increases its weight, volume and, last but not least, cost.

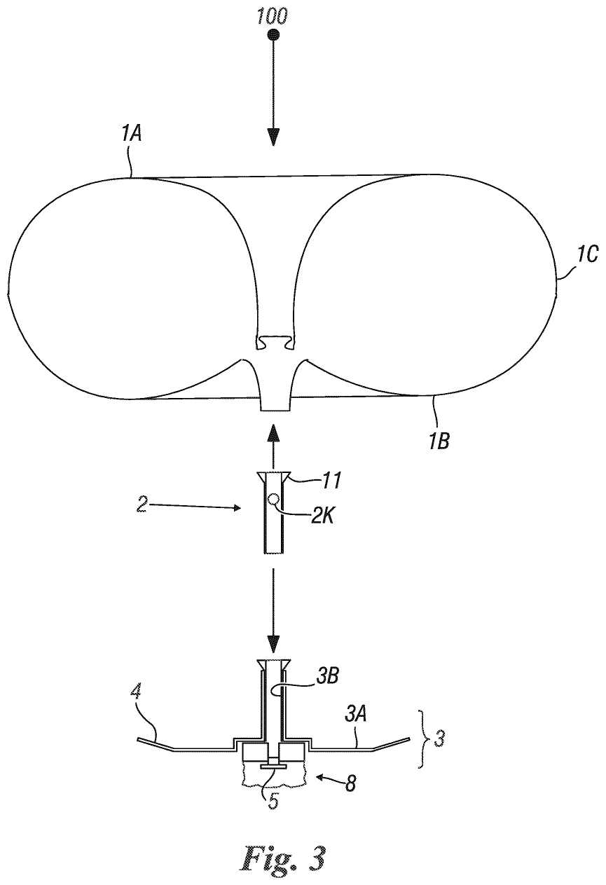

FIG. 3 shows the assembly of the loudspeaker 100: the support element 3, provided with plate 3A equipped with a central part 3B and edge 4, receives a coupling pipe 2, closed at one end, and the sealing cap 5, contained in the support body 8 or screw fitting for the coil 10 and adapted to close the other end of the pipe through which the air is introduced into the toroidal membrane 1. Such pipe 2 is screwed into the plate 3A and it is provided with a hole 2K for inflating the toroidal membrane 1 which is fixed with a sealing strip 7 (see FIG. 2). The toroidal membrane 1 is engaged-still deflated-to an engagement point 11 arranged at the end of pipe 2, and it is fixed with a strip 6 (FIG. 2). The membrane is then inflated. Then, the sealing cap 5 is assembled and the support body 8 of the coil 10 is coupled.

At the end of the assembly, the toroidal membrane 1 is integrally joined with the vibrating coil 10 in the central part of the toroid by constraining the membrane to the plate 3A of the support element 3 in turn connected to the support body 8 of the coil; this through the screw or bayonet-coupling system described above, formed by various rigid materials, for example plastic material. In order to prevent the membrane-plate assembly from altering the movement of the coil with its weight (despite weighing very few grams), unbalancing the axis, there may be provided for one or more centring elements (or simply “centring devices”) and/or counterweights 14 which help to keep the support element 3 (or rather its plate 3A) and the membrane 1 in axis with the movable or vibrating coil.

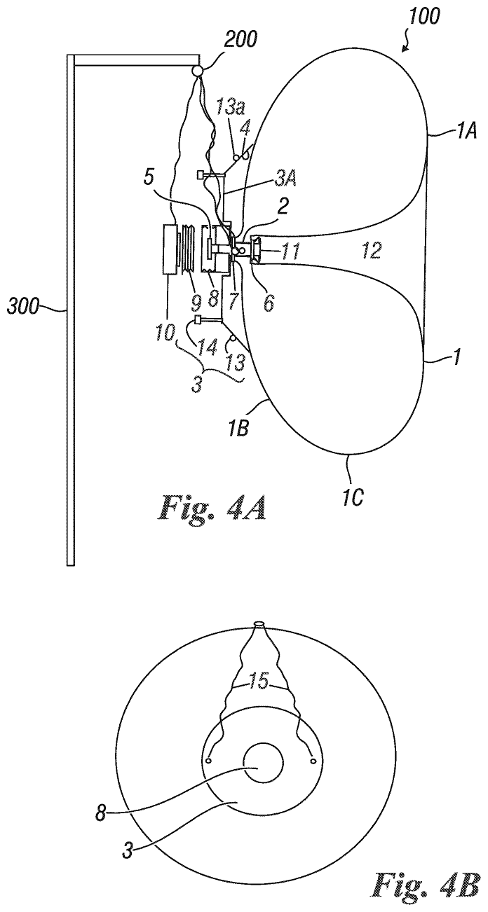

To such system there may be combined a hook for hanging the loudspeaker thus obtained (FIG. 4), or a fixed support structure (for example shaped like a pedestal or a frame that supports it). In this case, the toroidal membrane 1 may have fixing points 13, 13a adapted to cooperate with wires for supporting the loudspeaker by constraining the toroidal membrane to a support point 200 of a body or fixed support 300. This represents a variant of the presence of the hook.

An indoor or outdoor lighting element may be combined with the toroidal membrane.

The toroidal inflatable membrane made of a single piece 1 has its own rigidity due to the toroidal shape and to the air contained therein (which is of the low-pressure type and can be inserted without using any compressor). The avoids the need to use stiffening members like in DE102004007020.

For sound emission, DE4302593 provides for the use of a diaphragm in at least two parts, one dome-shaped and the other cone-shaped, which form a hermetic space which is filled with compressed air.

Furthermore, contrary to the case of DE4302593, the loudspeaker with toroidal inflatable membrane protruding laterally from the plate 3A may irradiate the sound not only frontally, but also at the sides of the plate that is in a substantially isotropic manner in the space (that is on the entire solid angle around the plate 3A—4π square radians) and it solves the problem of low frequencies in small loudspeakers, as described above.

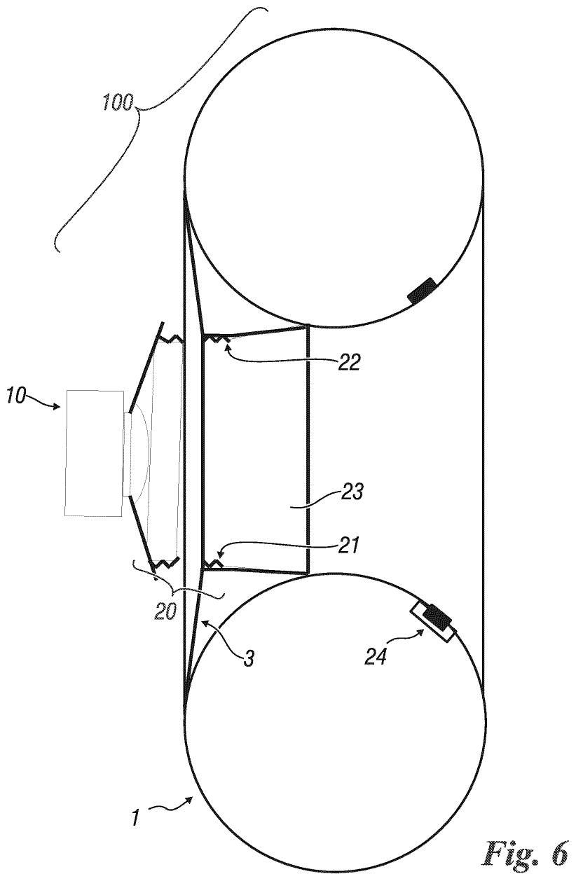

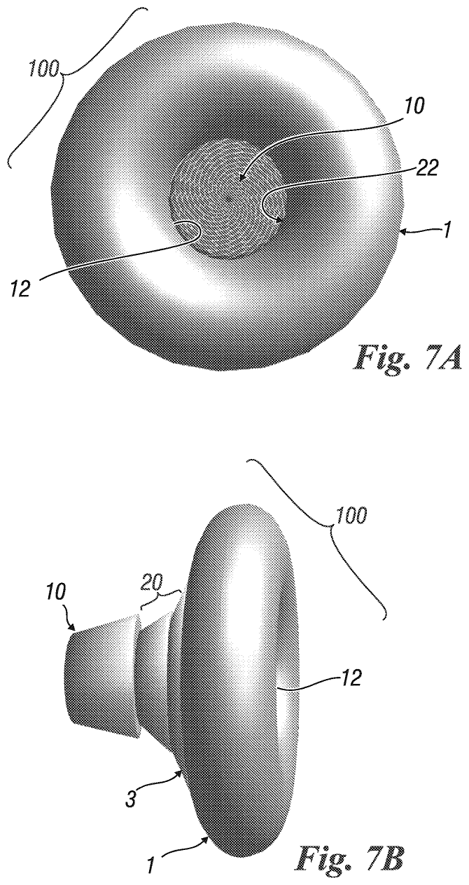

In an alternative version of the invention shown in FIGS. 6, 7A and 7B, the membrane is integrally joined with an engagement area 20 of the coil 10 which is a cylinder or truncated cone 22 with open opposite bases with a screw part (or of the bayonet type or the like) which is fixed to a corresponding area (for example threaded) 21 directly provided on an exposed part of the coil (basically creating a tweeter) so as to let the high frequencies produced by such coil to pass through the hole 12 of the toroidal membrane 1, frequencies which will be further amplified by the trumpet-cone-shape of the hole 12 of the toroidal membrane 1.

In such case, the loudspeaker will emit the high frequencies (produced by the exposed part of the coil), which will pass through the cylinder 22 and the hole 12 of the toroidal membrane 1, while the latter will emit the low frequencies through the surfaces thereof 1A, 1B, given that it is moved by the vibrations of the coil to which the membrane 1 is directly connected through the fitting areas 20-21.

The membrane can be inflated through an inflating area 24.

Therefore, the characteristic of the invention lies in the fact that the toroidal membrane is rigidly connected to the vibrating coil and it vibrates with it given that it is integrally joined with vibrating coil directly (for example at an exposed part of the coil, per se known). Therefore, the sound is generated, as it happens with the membrane of conventional loudspeakers. Given its shape and size, besides being rigid at ultra-low pressure (it can be blow-inflated), the toroidal membrane amplifies the frequencies that it emits given that it does not need further components or devices so as to operate. Given its shape and size, it is also capable of generating ultra-low frequencies and, last but not least, thanks to the toroidal shape protruding from the plate 3A, is capable of emitting the soundwaves substantially on the entire solid angle.

Furthermore, given the toroidal shape which suits both purposes, it simultaneously allows the production of low frequencies and the production-amplification of high frequencies through the cone formed at the centre of the toroid (trumpet-like loading of the high frequencies).

The proportion between the number, weight and overall dimensions of the components and the efficiency—amplitude of audio spectrum, is therefore much greater than the conventional loudspeakers.

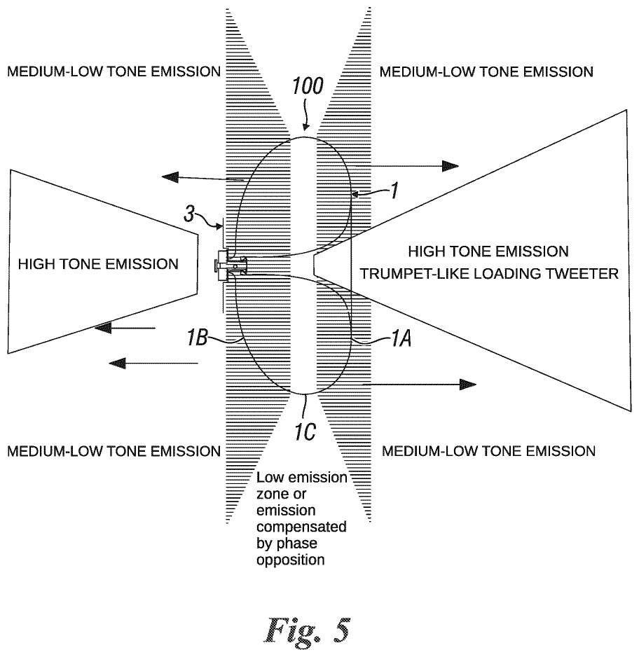

As observable in FIG. 5 the emission surface (perpendicular or almost perpendicular to the air compression direction) is much larger than the prior art solutions, and the area where the waves tend to nullify each other due to phase opposition is very small, and—on the contrary—it creates a line-area for virtually separating the two main faces 1A, 1B, allowing the at least partial conversion of the waves of one of the two faces (bass reflex effect-type) by simply appropriately positioning the loudspeaker, so that the low frequencies of the rear face 1B, bouncing against the near wall, end up summing to the waves produced by the front face.

The loudspeaker according to the invention allows to produce a high-quality sound; it is capable of emitting high frequency sounds, medium frequency sounds and deep bass sounds, with a single toroidal membrane—even small in size—without the common vented box. The loudspeaker is light and cost-effective. In addition, it generates a sound that spreads in the space (substantially at 360°) both at the front and rear areas through the faces 1A and 1B. These characteristics distinguish it from how loudspeakers available up to date are made/designed.

The loudspeaker according to the invention is a single loudspeaker capable of emitting a broad range of frequencies without requiring that it be constrained to a vented box that is without a closed box.

Therefore, the loudspeaker 100 allows to provide a new-concept audio system for the synergistic action of the applied physics principles, for components, sound generation and management and general characteristics.

### Advantageous Effects of the Invention

The market offers complete powerful amplifiers, with Bluetooth receiver, USB player, various inputs, etc. that cost tens of euros or slightly higher, and that measure a few centimetres e.g. 4×4-5×5, and weigh even a few grams; however, they have to be paired with proportionate acoustic or vented boxes that are at least as large as small pieces of furniture that are heavy, expensive and cumbersome.

The loudspeaker 100 encompasses all the characteristics required to produce high quality sound, with wide spectrum, without having to use loudspeakers with large rigid membranes, metal basket, wooden vented box and other various components. The toroidal membrane 1 (which can be separated from the coil 10) is characterised in that it is extremely light and at the same time rigid and it allows to emit sounds with various frequencies.

The loudspeaker 1 is therefore used without a vented box.

Therefore, by vibrating, the membrane generates the ultra-low frequencies, thanks to its surface, shape and volume characteristics. Therefore, the loudspeaker 100 overcomes the need for using any other component normally used as a vented box, except for the vibrating coil or the like (and a minimum support structure), whose size and power—thanks to the amplifying power of the membrane—may also be extremely reduced, without jeopardising the sound power and quality.

Besides emitting balanced low frequencies without the need for a vented box, the toroidal membrane allows to amplify acute sounds through the cone formed at the centre of the toroidal membrane (called “trumpet-like loading” of tweeters), for a powerful and balanced sound.

The loudspeaker 100 has a membrane 1 that is easy to inflate and deflate; once deflated, the loudspeaker has ultra-small dimensions, weight and volume. In addition, it is easily pocketable. This makes it extremely easy to transport thanks to the essentiality of its components. It is also extremely cost-effective compared to systems of the same quality.

The combined shape, lightness and rigidity characteristics make the loudspeaker 100 very sensitive. Therefore, it is capable of emitting many harmonics, low frequencies and a full and balanced sound even at low volume which adapts to small and large environments alike. Background listening does not jeopardise the warmth and completeness of the sound. Therefore, the loudspeaker 100 allows to simultaneously emit low-frequency sounds and high frequency sounds which are also amplified by the shape (substantially cone-like) of the central part 12 of the toroidal membrane 1.

The loudspeaker according to the invention is capable of making the low frequencies—which are usually not directional in conventional systems—more directional, given that the lower the frequencies, the more they spread evenly in the environment. This is due to the fact that in the loudspeaker 100, the faces 1A and 1B of the inflated membrane 1 operate in phase opposition and therefore, laterally (all-around) to the toroidal membrane, the sound and the bass sounds are partly attenuated, while they are more marked frontally to both faces.

Therefore, the loudspeaker 100 allows to manage the sound directing the membrane, depending on its needs and create “corridors” or areas where the sound is more attenuated and others where it is higher, considering the same distance from the loudspeakers. (see FIG. 5).

The face 1B which is arranged facing-at the rear part—towards a wall can generate a bass reflex effect depending on the distance from such wall—rear acoustic obstacles, orientation, etc.

Two loudspeakers 100 can also be fixed with the membranes 1 opposite to each other (magnet against magnet) and they can be connected in phase opposition, so that the thrust (on the corresponding membrane) of a coil is reinforced by the reverse-thrust of the other; this allows to increase the power of the sound emitted by the membranes.

Or two membranes and relative coils—arranged in a front-rear fashion with respect to each other can be combined and connected with opposite electric poles (in phase opposition), so as to sum together and merge the timbres emitted by each face, or other combinations.

In the light of the above, in the loudspeaker 100, the characteristics of the sound can be modified at will through various combinations (not only the ones described, which are non-limiting examples of the invention), by differently directing the loudspeakers or by easily replacing the membranes with others of different dimensions obtaining different timbres.

The characteristics of the invention are however defined by the claims that follow.

1. Loudspeaker comprising a magnet, a movable coil, a body for supporting the movable coil and an inflatable body defining a membrane of the loudspeaker which converts the movement of the movable coil into sound, wherein the membrane is rigidly connected to a support element of the membrane fixed to the body for supporting the movable coil, said membrane being made of a single piece, which is toroidal-shaped and protruding from the support element, said membrane having a first free surface distal from the support element and a second free surface proximal to the support element and protruding from the sides of the support element, both said first and second surfaces emitting a sound following the movement of the coil.

2. Loudspeaker according to claim 1, wherein said toroidal inflatable membrane is connected to the movable coil through the body to which the support element of the membrane is constrained.

3. Loudspeaker according to claim 1, wherein the toroidal inflatable membrane cooperates with a pipe fixed to the support element of the membrane, said pipe having a hole for inflating the toroidal membrane and being closed at one end and open at the other for inflating and deflating the toroidal membrane , said open end of the pipe cooperating with a closing cap.

4. Loudspeaker according to claim 1, wherein the movable coil is provided with a threaded part configured for screwing to the support body integrally joined with the support element of the membrane or for a bayonet coupling to such support body.

5. Loudspeaker according to claim 1, that wherein the support element comprises a plate to which there is fixed a toroidal inflatable membrane made of a single piece.

6. : Loudspeaker according to claim 5, wherein said plate has foldable protruding arms.

7. Loudspeaker according to claim 1, comprising at least one centering element configured to maintain said toroidal membrane on axis with the movable coil.

8. Loudspeaker according to claim 7, wherein said centering element provides for external counterweights integrally joined with the support element to keep the support element and the toroidal membrane on axis with the movable coil.

9. Loudspeaker according to claim 1, wherein the toroidal membrane is combined with an element for indoor and outdoor lighting.

10. Loudspeaker according to claim 1, comprising elements for constraining the toroidal membrane to support members and to a fixed element configured to allow the loudspeaker to be supported by, hung on, a fixed structure.

11. Loudspeaker according to claim 1, wherein the loudspeaker emits sounds having a range of frequencies that range from low to high frequencies.

12. Loudspeaker according to claim 1, wherein the toroidal inflatable membrane has a central hole through which the high frequency sound generated by the movable coil passes.

13. Loudspeaker according to claim 12, wherein the high frequency sounds are amplified by the central part of the trumpet-cone-shaped membrane.

14. Loudspeaker according to claim 1, wherein the toroidal membrane is replaceable.
